(19) United States
(12) Patent Application Publication
(10) Pub. No.: US 2002/0194229 A1
(43) Pub. Date: Dec. 19, 2002

(54) Network-based spell checker

(76) Inventors: Jerry B. Decime, Eagle, ID (US); Marcus Richard Nilson, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/882,940

(22) Filed: Jun. 15, 2001

(51) Int. Cl. G06F 15/00

(52) U.S. Cl. 707/533

(57) ABSTRACT

The present disclosure relates to a system and method for checking the spelling of words. The system and method involve identifying an unfamiliar word, generating at least one alternative spelling of the unfamiliar word to create a word variant, providing the unfamiliar word and the at least one word variant to a search engine configured to search for a frequency of use of the unfamiliar word and the at least one word variant, and presenting the results of the word search to the user.

### FIELD OF THE INVENTION

The present disclosure relates to a network-based spell checker. More particularly, the disclosure relates to a system and method in which a network word search is conducted to help a user to determine the correct spelling of a word.

### BACKGROUND OF THE INVENTION

Most word processing and electronic mail (email) applications include a spell checking feature, commonly referred to as a “spell checker,” that compares words contained within a document with those stored by the application in a word database in an attempt to identify misspelled words. By way of example, when the spell checker is activated, it scans the document until it identifies an unfamiliar word. When it does, the spell checker typically generates a pop-up dialogue box that alerts the user that it has located an unknown word which potentially is misspelled. Typically, the dialogue box also presents several different spelling suggestions to the user. These suggestions are selected by the spell checker from the word database according to an algorithm that selects the words that most closely approximate the unfamiliar word located within the document. Due to this configuration, the spell checker may present the user with alternative (and therefore correct) spellings of the intended word and/or other similarly spelled words. Once presented with the suggestions, the user can ignore the suggestions and leave the original spelling, or select one of the suggested words to replace the unfamiliar word.

Conventional spell checkers of the sort described above are limited by their existing “vocabulary,” i.e., the collection of words the spell checker maintains in its word database. Accordingly, spell checkers often incorrectly identify correctly spelled, although more recently coined, words. This can be especially true for words that pertain to emerging technologies such as those that support the Internet and the World Wide Web (WWW). For this reason, most spell checkers allow the user to add words that the user presumably believes to be correctly spelled to the word database. For instance, where the spell checker identifies a word it does not recognize which the user believes to be correctly spelled, the user can select an “add” button in the dialogue box to add the word to the database. Once the word is added to the database, the spell checker will recognize it as being correctly spelled next time the spell checker encounters the word.

Although, as noted above, spell checkers normally provide several alternative suggestions to the user, it can be difficult for the user to determine which spelling is correct. If the user is unsure about the correct spelling after viewing the suggestions of the spell checker, the user typically has no choice but to leave the word as originally spelled, guess as to which suggested alternative spelling to select, or consult another reference such as a dictionary to confirm the correct spelling of the word. Clearly, none of these options are very attractive in that the first two may result in the user's document containing a misspelled word and the third is time-consuming or may not even be feasible where the user does not have access to an appropriate reference. Where the user feels relatively sure about the original spelling of a word and decides to add the word to the spell checker word database, the user risks repeating the same spelling mistake over and over if he or she was incorrect as to the spelling of the word.

To alleviate the limitations of conventional spell checkers such as those used in word processing and email programs, Internet-based spell checkers have been created that can be accessed online. Although these spell checkers are more dynamic in that their word databases can be updated by the service provider as new words are coined, limitations to their effectiveness exist. For instance, if a new term is used in a document that has not yet been stored in the word database, the spell checker may incorrectly identify the word as being misspelled. In addition, even where the word is not new, the user may still be unsure about the correct spelling of the word after being presented with the spell checker suggestions. Finally, the utility of any known spell checker, either off line or online, is limited by the various words that it has stored in the word database.

From the foregoing, it can be appreciated that it would be desirable to have a system and method for checking the spelling of words that avoids one or more of the drawbacks identified above.

### SUMMARY OF THE INVENTION

The present disclosure relates to a method for checking the spelling of words. The method comprises the steps of identifying an unfamiliar word, generating at least one alternative spelling of the unfamiliar word to create a word variant, providing the unfamiliar word and the at least one word variant to a search engine configured to search for a frequency of use of the unfamiliar word and the at least one word variant, and presenting the results of the word search to the user.

The disclosure also relates to a system for checking the spelling of words. The system comprises means for identifying an unfamiliar word, means for generating at least one alternative spelling of the unfamiliar word to create a word variant, means for providing the unfamiliar word and the at least one word variant to a search engine configured to search for a frequency of use of the unfamiliar word and the at least one word variant, and means for presenting the results of the word search to the user.

Furthermore, the disclosure relates to a computer readable medium including a program for checking the spelling of words. The program comprises logic configured to identify an unfamiliar word, logic configured to generate at least one alternative spelling of the unfamiliar word to create a word variant, logic configured to provide the unfamiliar word and the at least one word variant to a search engine configured to search for a frequency of use of the unfamiliar word and the at least one word variant, and logic configured to present the results of the word search to the user.

Other features, advantages, systems, and methods provided by the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view of a system for providing spell checking.

FIG. 2 is a schematic view of a computing device shown in FIG. 1.

FIG. 3 is a schematic view of a network server shown in FIG. 1.

FIG. 4 is a flow diagram that illustrates operation of a spell check module shown in FIG. 2.

FIG. 5 is a flow diagram that illustrates operation of a word search engine shown in FIG. 3.

### DETAILED DESCRIPTION

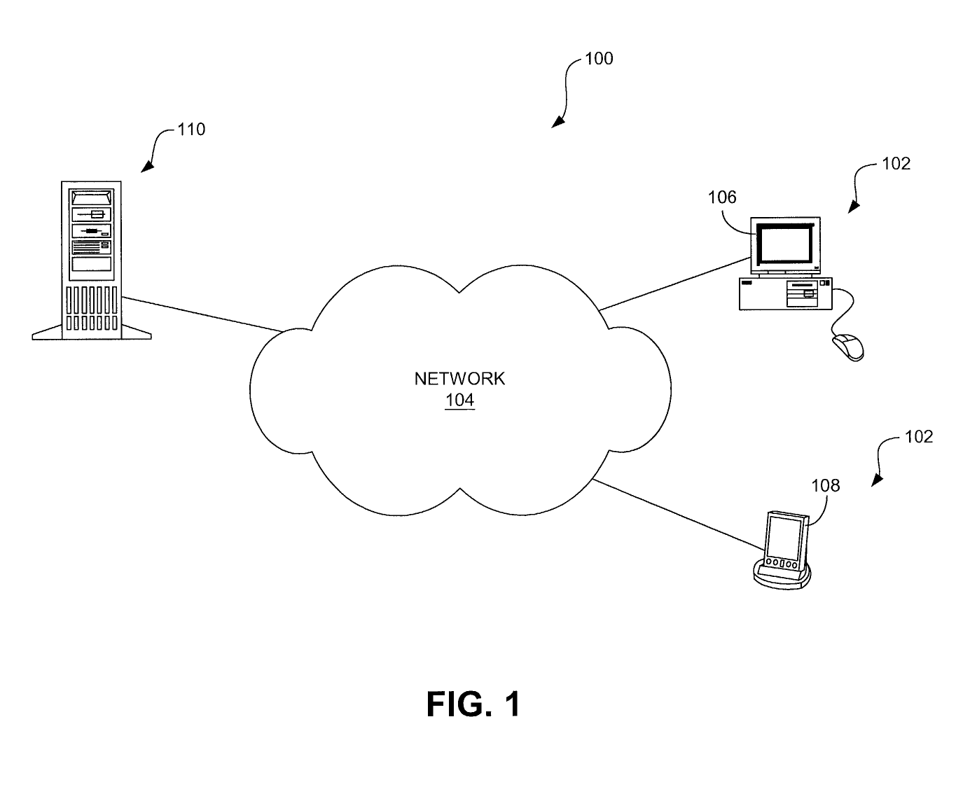

Referring now in more detail to the drawings, in which like numerals indicate corresponding parts throughout the several views, FIG. 1 illustrates a system 100 for providing spell checking. As indicated in this figure, the system 100 can comprise one or more computing devices 102 that are each connected to a network 104. As suggested by FIG. 1, the computing devices 102 can have various configurations. For instance, the computing devices 102 can comprise a desktop personal computer (PC) 106 and a handheld device such as a personal digital assistant (PDA) 108. However, as will be apparent from the discussion that follows, the particular configuration of the computing device 102 is important as compared to the fact that the computing device includes an application in which a spell checker can be used and that the computing device is in some way connected to the network 104 (directly or wirelessly) and is therefore capable of communicating with other devices via the network.

The network 104 can comprise one or more sub-networks (i.e., subnets) that are communicatively coupled. By way of example, these networks can include a local area network (LAN) and/or a wide area network (WAN). In a preferred arrangement, however, the network 104 comprises a set of networks that forms part of the Internet. Further included in the system 100 shown in FIG. 1 is at least one network server 110. As indicated in the figure, the server 110 is connected to the network 104, typically through a direct, physical connection.

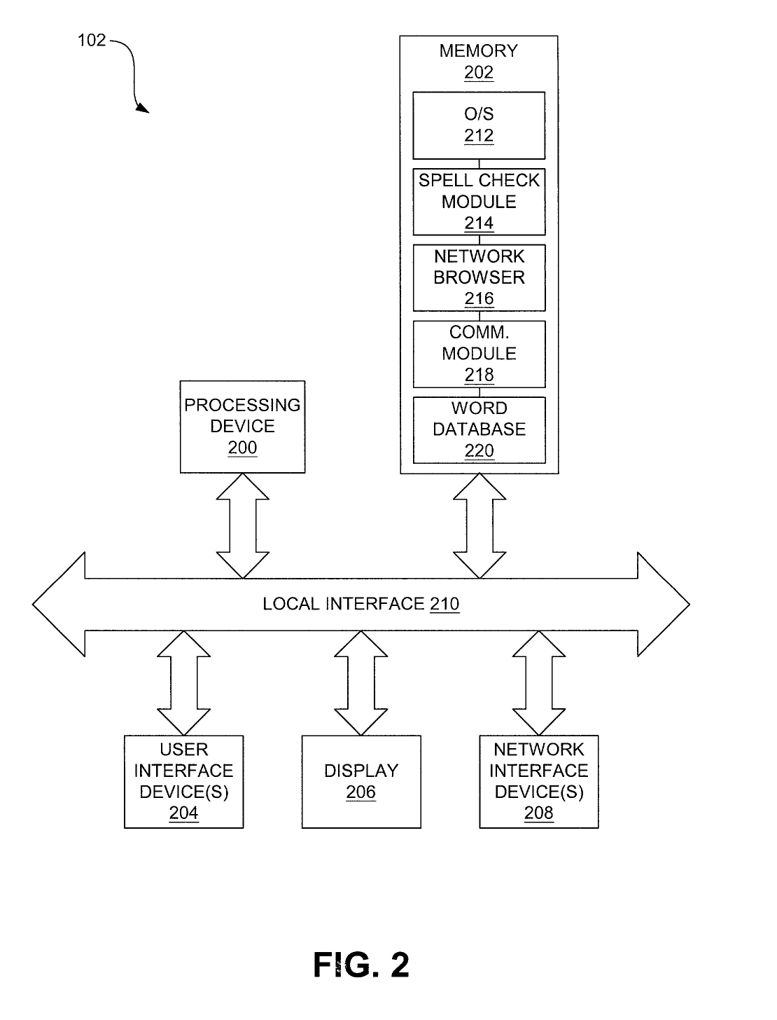

FIG. 2 is a schematic view illustrating an example architecture for the computing devices 102 shown in FIG. 1. As indicated in FIG. 2, each computing device 102 can comprise a processing device 200, memory 202, one or more user interface devices 204, a display 206, one or more network interface devices 208, and a local interface 210 to which each of the other components electrically connects. The processing device 200 can include any custom made or commercially available processor, a central processing unit (CPU) or an auxiliary processor among several processors associated with the computing device 102, a semiconductor based microprocessor (in the form of a microchip), or a macroprocessor. The memory 202 can include any one of combination of volatile memory elements (e.g., random access memory (RAM, such as DRAM, SRAM, etc.)) and nonvolatile memory elements (e.g., ROM, hard drive, tape, CDROM, etc.).

The user interface devices 204 typically comprise those normally used in conjunction with a computing device. For instance, where the computing device 102 comprises a desktop PC, the user interface devices 204 can comprise a keyboard, mouse, etc. Where the computing device 102 comprises a handheld device, such as PDA 108, the interface devices 204 can comprise a touch-sensitive liquid crystal display (LCD) and/or one or more function keys. The configuration of the display 206 also normally depends upon the configuration of the computing device 102. For instance, where the computing device 102 comprises a desktop PC, the display typically comprises a monitor. Where the computing device 102 comprises a handheld device, the display 206 can comprise the touch-sensitive screen, where provided, or another LCD provided on the device. The one or more network interface devices 208 comprise the hardware with which the computing device 102 transmits and receives information over the network 104. By way of example, the network interface devices 308 include components that communicate both inputs and outputs, for instance, a modulator/demodulator (e.g., modem), a radio frequency (RF) or other transceiver, a telephonic interface, a bridge, a router, etc.

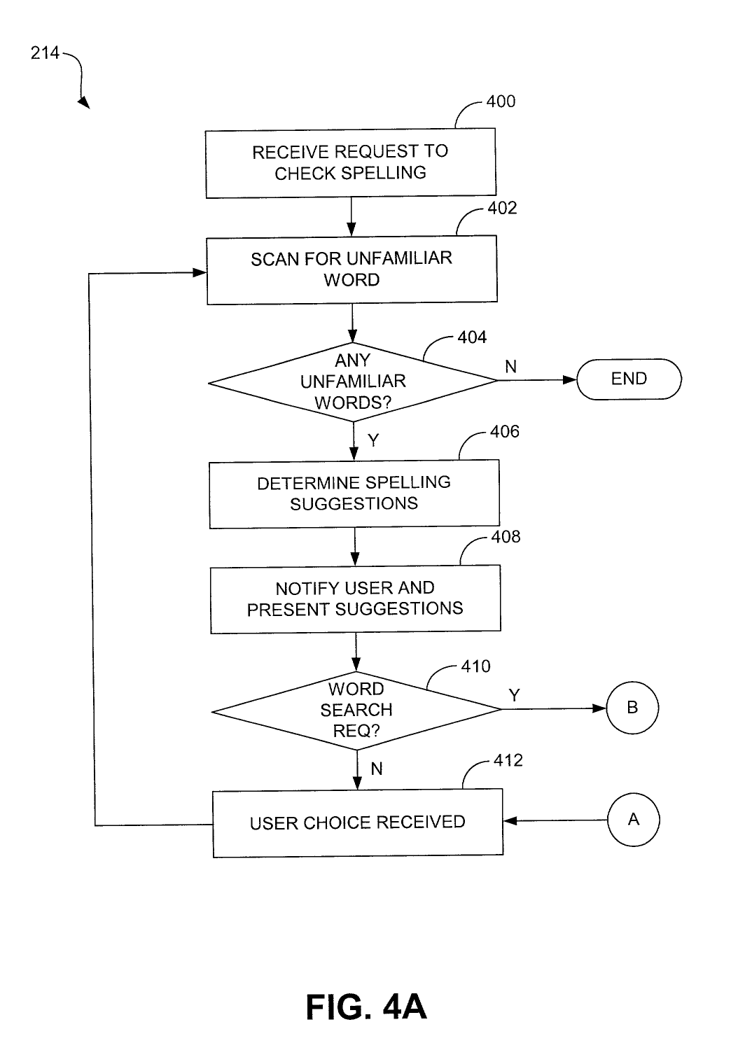

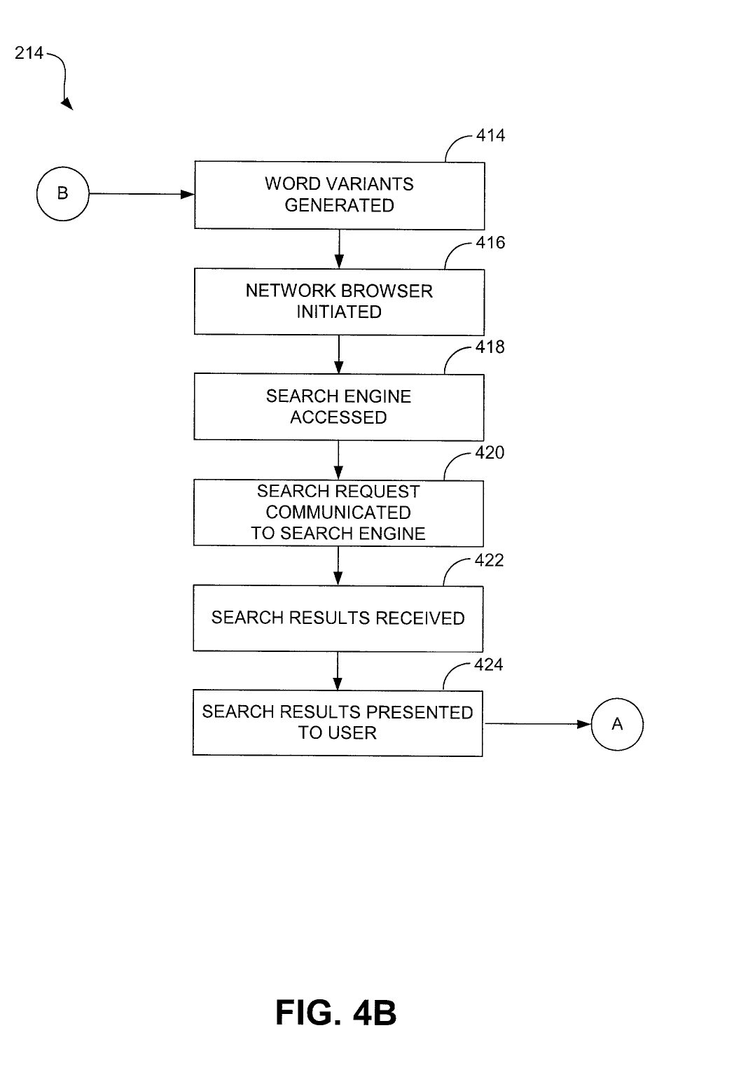

The memory 202 comprises various software and/or firmware programs including an operating system 212, a spell check module 214, network browser 216, and a communications module 218. The operating system 212 controls the execution of other software, such as the spell check module 214, network browser 216, and communications module 218, and provides scheduling, input-output control, file and data management, memory management, and communication control and related services. The spell check module 214 comprises the various software with which, as is described in detail below, the spelling of words in a document can be checked. As used herein, the term “document” refers to any collection of words that contains individual words which can be spell checked. The spell check module 214 uses the network browser 216 to access a network search engine via the communications module 218. The operation of the spell check module 214 is discussed in detail in relation to FIG. 4. Also shown within the memory 202 is a word database 220 that, as is described below, is used to store correctly spelled words that the spell check module 214 can reference when conducting a spell check of a document.

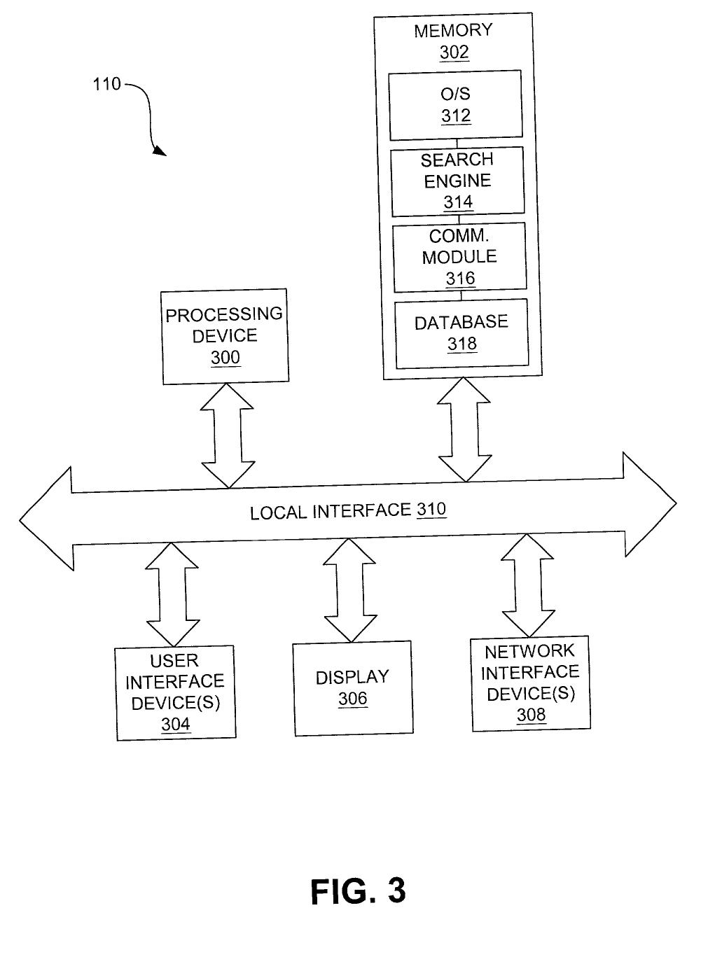

FIG. 3 is a schematic view illustrating an example architecture for the network server 110 shown in FIG. 1. As indicated in FIG. 3, the network server 110 can be similar to that of the computing devices 102 and can therefore comprise a processing device 300, memory 302, one or more user interface devices 304, a display 306, and one or more network interface devices 308. Each of these components is connected to a local interface 310 that, by way of example, comprises one or more internal buses. The local interface 310 may have additional elements, which are omitted for simplicity, such as controllers, buffers (caches), drivers, repeaters, and receivers to enable communications. Furthermore, the local interface 310 may include address, control, and/or data connections to enable appropriate communications among the aforementioned components.

The processing device 300 comprises hardware for executing software that is stored in memory 302 and can include any custom made or commercially available processor, a central processing unit (CPU), an auxiliary processor among several processors associated with the network server 110, a semiconductor based microprocessor (in the form of a microchip), or a macroprocessor. The memory 302 can include any one of combination of volatile memory elements (e.g., random access memory (RAM, such as DRAM, SRAM, etc.)) and nonvolatile memory elements (e.g., ROM, hard drive, tape, CDROM, etc.). Moreover, the memory 302 can incorporate electronic, magnetic, optical, and/or other types of storage media. Note that the memory 302 can have a distributed architecture, where various components are situated remote from one another, but accessible by the processing device 300.

The one or more user interface devices 304 typically comprise those normally used in conjunction with a server such as a keyboard, mouse, etc., and the display 306 typically comprises a monitor. The one or more network interface devices 308 comprise the hardware with which the network server 110 transmits and receives information over the network 104. By way of example, the network interface devices 308 include components that communicate both inputs and outputs, for instance, a modulator/demodulator (e.g., modem), a radio frequency (RF) or other transceiver, a telephonic interface, a bridge, a router, etc.

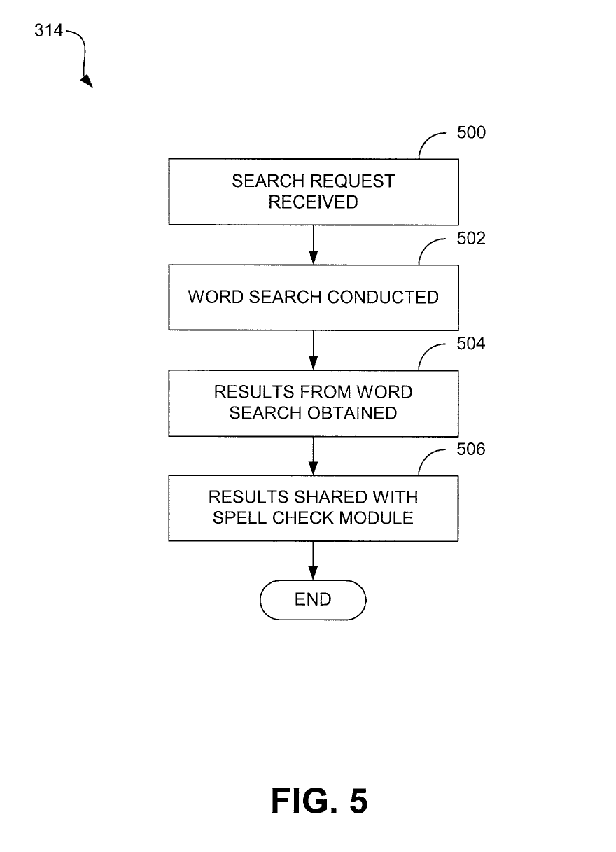

As indicated in FIG. 3, the memory 302 comprises various software programs. In particular, the memory 302 includes an operating system 312, a network search engine 314, and a communications module 316. The operating system 312 controls the execution of other software, such as the network search engine 314 and the communications module 316, and provides scheduling, input-output control, file and data management, memory management, and communication control and related services. The network search engine 314 conducts searches of a database 318 stored within the memory 302 to determine the frequency of use of certain words that are presented to it. This frequency can then be communicated to the user with the communications module 316, which operates in conjunction with the network interfaces device(s) 308. The operation of the network search engine 314 is provided below in relation to FIG. 5.

Various software and/or firmware programs have been described herein. It is to be understood that these programs can be stored on any computer readable medium for use by or in connection with any computer related system or method. In the context of this document, a computer readable medium is an electronic, magnetic, optical, or other physical device or means that can contain or store a computer program for use by or in connection with a computer related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium could even be paper or another suitable medium upon which a program is printed, as the program can be electronically captured, via for instance optical scanning of the paper or other medium, then compiled, interpreted or otherwise processed in a suitable manner if necessary, and then stored in a computer memory.

FIGS. 4A and 4B illustrate operation of the spell check module 214. As indicated in block 400 of FIG. 4A, the spell check module 214 receives a request to check the spelling of the words contained within a document. By way of example, this request can be initiated by the user by, for instance, selecting a check spelling button provided within a word processing application. Alternatively, the request can be initiated by an application, for example email application, automatically in response to some predetermined criterion, e.g., selection of a “send” button of the email application. In any case, the spell check module 214 scans the document for unfamiliar words, as indicated in block 402. In particular, the spell check module 214 searches the word database 220 for each of the words contained within the document to ensure that each is also contained within the word database and, therefore, is correctly spelled.

Flow continues to decision element 404 at which the spell check module 214 determines if an unfamiliar word (i.e., one not contained within the word database 220) is encountered. If not, the words contained within the document are presumably correctly spelled and flow is terminated. If an unfamiliar word is encountered, however, flow continues to block 406 at which the spell check module 214 determines which words to suggest, if any, to the user as a replacement for the unfamiliar word. Typically, the word suggestions are determined according to an algorithm contained within the spell check module 214 that selects one or more correctly spelled words from the word database 220 that are similar to the unfamiliar word. Normally, the algorithm will identify several such words. Once the word suggestions, if any, have been determined, the user is notified that an unfamiliar word has been identified and the suggestions are presented to the user, as indicated in block 408. By way of example, this notification can comprise a message that is presented to the user with a pop-up dialogue box as is conventional in the art.

At this point, it can be determined whether a network word search is requested, as indicated in decision element 410. This request can be generated in a variety of ways. For instance, if the spell check module 214 does not generate any suggestions for the unfamiliar word, the spell check module can be pre-configured to automatically initiate the network word search. In another example, the user can be given the option of requesting the network word search where, for instance, the user is still unsure about the correct spelling of the word even after being presented with the suggestions. If a search request is not generated, flow continues to block 412 at which the user choice received. By way of example, the user can choose a word suggested by the spell check module 214 or opt to ignore the notification and leave the word as originally spelled. Once this selection is made, flow then can return to block 402 where the remainder of the words within the document can be spell checked.

If a network word search is requested, however, flow continues to block 414 in FIG. 4B at which word variants are generated by the spell check module 214. Specifically, the module 214 generates variants of the unfamiliar word that, as is discussed below, will be used as key words in a word search conducted by the network search engine 314 of the server 110. Typically, the word variants are generated by an algorithm of the spell check module 214 that is configured to generate the variants according to certain predetermined rules. By way of example, the algorithm can be adapted to replace vowels and/or consonants of the unfamiliar word with phonetic equivalent (i.e., similar sounding) vowels and/or consonants to generate phonetic equivalent words variants that can be used in the word search. For instance, the algorithm can be configured to replace “u” with “ue” and “ou” with “owe” and so forth until several similar sounding variants of the unfamiliar word are created. Once the variants are created, the network browser 216 can be initiated, as indicated in block 416. Notably, the network browser 216 can be launched by the spell check module 214 immediately once the word search request is received, if desired.

The network browser 216 can comprise an application that is associated with the spell check module 214 and, for instance, provided along with the spell check module in a package arrangement. Alternatively, the spell check module 214 can leverage an existing network browser (e.g., Microsoft™ Internet Explorer™) on the computing device 102. In either case, the network browser 216 accesses the network 104 and, more particularly, accesses one or more network search engines, such as search engine 314 of the network server 110, as indicated in block 418. Like the browser 216, the network search engine 314 can comprise an engine associated with and specifically adapted for the spell check module 214, or can comprise an existing network search engine (e.g., Lycos.com™). Once the search engine is accessed, a word search request can be communicated by the spell check module 214 to the search engine, as indicated in block 420. In particular, the unfamiliar word, as well as several (e.g., ten) of the generated word variants, are provided to the network search engine as key words to be searched for by the engine.

At this point, reference is made to FIG. 5 which illustrates the operation of the network search engine 314. As indicated in block 500 of FIG. 5, the network search engine 314 receives the word search request that comprises the unfamiliar word and the generated variants. Once the request, and the various words, have been received, the network search engine 314 conducts a word search of the database 318, as indicated in block 502. By way of example, the database 318 contains a collection of network sites and pages. In a preferred arrangement, the database 318 comprises multitudes of web sites and web pages accessible over the network 104 and, more particularly the World Wide Web. Preferably, the database 318 is frequently updated by the search service provider such that the network search engine 314 can search the most recent documents available which are most likely to contain frequently used words as well as newly coined words that are not yet in common use and therefore unlikely to be recognized by a conventional spell checker. The search engine 314 therefore surveys the database 318 to determine the most frequently appearing, and therefore the most common spellings, of the word at issue.

Once the search has been completed, the search results are obtained by the network search engine 314, as indicated in block 504. By way of example, the search engine 314 can be configured to determine the number of “hits” found or percentage of each word. Once this information has been obtained, the search results can be shared with the spell check module 214, as indicated in block 506. Flow for the network search engine 314 is then terminated.

Returning to FIG. 4 and block 422, the word search results are received by the spell check module 214. The spell check module 214 then presents these results to the user, as indicated in block 424. More particularly, the searched words and their frequency of use can be presented to the user, and the user can be provided with the option of selecting one of the searched words to replace the word that was unfamiliar to the spell check module 214. These results can be presented in a variety of ways. For instance, the user can be provided with the number of hits for each spelling, the percentage use of each spelling, a graphical representation of frequency, etc. Regardless of the particular manner in which the frequency of use information is presented to the user, the user will be able to determine which word or words, and therefore which of the various alternative spellings of the unfamiliar word, is/are most common and, therefore, most likely to be correct. Normally, the correctly spelled word will appear with much greater frequency than the incorrectly “words” such that the correct choice will be clear to the user. Accordingly, the user can normally identify the correct spelling of the word at issue with some degree of certainty.

At this point, flow can return to block 412 in FIG. 4A at which the user choice can be received. Again, this choice can be the choice to leave the word as originally spelled or to select one of the word variants that were the subject of the word search conducted by the network search engine 314. Optionally, the user can still choose one of the suggested words originally generated by the spell check module 214 before the word search was conducted. Next, flow returns to block 402 at which the remainder of words contained within the document can be checked for incorrect spelling.

From the above description it can be appreciated that the spell check module 214 can be utilized to not only present word replacement suggestions to the user but also to give the user a better idea as to which of the suggestions is most likely the correctly spelled version of the word. Moreover, it can be appreciated that, due to the network word search, much newer words can be spell checked. It is to be noted that, although the spell check module 214 has been illustrated and described herein as comprising part of the computing device 102, the module could, alternatively, be located in one or more other locations. For instance, persons having ordinary skill in the art will appreciate that the spell check module 214, or a portion thereof, could be stored on a network server, such as server 110, and could be accessed remotely via the network 104. For example, the spell check module 214 could be used in conjunction with an Internet-based email application. Irrespective of its placement, however, the spell check module 214 operates in substantially the same manner to provide the user with greater help in making spelling choices.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for checking the spelling of words, comprising the steps of:
identifying an unfamiliar word;
generating at least one alternative spelling of the unfamiliar word to create a word variant;
providing the unfamiliar word and the at least one word variant to a search engine configured to search for a frequency of use of the unfamiliar word and the at least one word variant; and
presenting the results of the word search to the user.

2. The method of claim 1, wherein the step of identifying an unfamiliar word comprises determining whether a word is stored within a word database.

3. The method of claim 2, further comprising the steps of presenting the user with word suggestions based upon similarly spelled words located within the word database.

4. The method of claim 1, wherein the at least one alternative spelling is generated by an algorithm configured to replace letters of the unfamiliar word with similarly sounding letters.

5. The method of claim 1, wherein the step of providing the unfamiliar word and the at least one word variant to a search engine comprises transmitting the unfamiliar word and the at least one word variant to the search engine via a network from a remote location.

6. The method of claim 5, wherein the search engine comprises an Internet search engine.

7. The method of claim 1, wherein the step of presenting results to the user comprises presenting an indication of the frequency with which the unfamiliar word and the at least one word variant appear within a database.

8. The method of claim 7, wherein the frequency is expressed in terms of number of hits for the unfamiliar word and the at least one word variant.

9. The method of claim 7, wherein the frequency is expressed in terms of a percentage.

10. The method of claim 7, further comprising the step of permitting the user to select the at least one word variant to replace the unfamiliar word after receiving the frequency information.

11. A system for checking the spelling of words, comprising:
means for identifying an unfamiliar word;
means for generating at least one alternative spelling of the unfamiliar word to create a word variant;
means for providing the unfamiliar word and the at least one word variant to a search engine configured to search for a frequency of use of the unfamiliar word and the at least one word variant; and
means for presenting the results of the word search to the user.

12. The system of claim 11, further comprising means for presenting the user with suggested words that have similar spellings to the unfamiliar word.

13. The system of claim 11, wherein the means for generating at least one alternative spelling comprise an algorithm configured to replace letters of the unfamiliar word with similarly sounding letters.

14. The system of claim 1, wherein the means for presenting results to the user comprise means for presenting an indication of the frequency with which the unfamiliar word and the at least one word variant appear within a database.

15. The system of claim 14, further comprising means for permitting the user to select the at least one word variant to replace the unfamiliar word after receiving the frequency information.

16. A computer readable medium including a program for checking the spelling of words, comprising:
logic configured to identify an unfamiliar word;
logic configured to generate at least one alternative spelling of the unfamiliar word to create a word variant;
logic configured to provide the unfamiliar word and the at least one word variant to a search engine configured to search for a frequency of use of the unfamiliar word and the at least one word variant; and
logic configured to present the results of the word search to the user.

17. The computer readable medium of claim 11, further comprising logic configured to present the user with suggested words that have similar spellings to the unfamiliar word.

18. The computer readable medium of claim 11, wherein the logic configured to generate at least one alternative spelling comprises an algorithm configured to replace letters of the unfamiliar word with similarly sounding letters.

19. The computer readable medium of claim 1, wherein the logic configured to present results to the user comprises logic configured to present an indication of the frequency with which the unfamiliar word and the at least one word variant appear within a database.

20. The computer readable medium of claim 19, further comprising logic configured to permit the user to select the at least one word variant to replace the unfamiliar word after receiving the frequency information.
